(19) United States
(12) Patent Application Publication
(10) Pub. No.: US 2026/0210409 A1
(43) Pub. Date: Jul. 23, 2026

(54) TRIPOD CONSTANT-VELOCITY JOINT

(71) Applicant: JTEKT CORPORATION, Kariya-shi (JP)

(72) Inventors: Kenji OISO, Aichi (JP); Keishi KOBATA, Aichi (JP); Akihiko HASEGAWA, Aichi (JP)

(73) Assignee: JTEKT CORPORATION, Kariya-shi (JP)

(21) Appl. No.: 19/144,797

(22) PCT Filed: Jan. 23, 2023
(86) PCT No.: PCT/JP2023/001882

§ 371 Date: Jun. 30, 2025

(51) Int. Cl. F16D 3/205

(52) U.S. Cl. CPC F16D 3/2055

(57) ABSTRACT

A tripod constant-velocity joint includes an outer ring, a tripod, and a plurality of roller units. Each of the plurality of roller units has an outer roller, an inner roller, and a needle that is cylindrical and that is sandwiched between the outer roller and the inner roller. A needle count (A), a needle diameter (B), and a circumferential direction clearance (C), of the needles (33), are set to values that satisfy the following Expression (1): (C/(A×B+C)×100≥0.678.

### TECHNICAL FIELD

The present disclosure relates to a tripod constant-velocity joint.

### BACKGROUND ART

Patent Document 1 below discloses this type of tripod constant-velocity joint. A roller unit that makes up this tripod constant-velocity joint has an outer roller, an inner roller, and a rolling element that is cylindrical and that is sandwiched between the outer roller and the inner roller. In order to suppress generation of a compelling force due to change in a joint angle, this tripod constant-velocity joint is configured such that a clearance between the inner roller and a regulating portion on the outer roller side is greater than reciprocating force between a trunnion and the inner roller at a normal operating angle of the joint, and smaller than a crowning length of the rolling element.

### RELATED ART DOCUMENTS

### Patent Documents

Patent Document 1: Japanese Unexamined Patent Application Publication No. 2020-190250 (JP 2020-190250 A)

### SUMMARY OF THE INVENTION

The above tripod constant-velocity joint is an attempt to suppress the compelling force that is applied by the inner roller, by optimizing the clearance between the inner roller and the regulating portion on the outer roller side, and suppressing the inner roller from contacting the regulating portion, but technology that can further suppress the compelling force is necessary in order to improve quietness.

The present disclosure provides a tripod constant-velocity joint that is excellent in quietness.

One aspect of the present disclosure is a tripod constant-velocity joint including an outer ring having a plurality of raceway grooves extending in an axial direction, a tripod having three shaft portions, and a plurality of roller units formed in an annular shape, rotatably supported on each of the three shaft portions, and also each rolling in each of the plurality of raceway grooves, in which each of the plurality of roller units has an outer roller, an inner roller, and a needle that is cylindrical and that is sandwiched between the outer roller and the inner roller, and a needle count, a needle diameter, and a circumferential direction clearance, of the needles, are set to values that satisfy the following Expression (1): (C/(A×B+C))×100≥0.678 . . . (1).

### Effects of the Invention

According to the tripod constant-velocity joint of the above aspect, the circumferential direction clearance of the needles can be expanded by setting the needle count, the needle diameter, and the circumferential-direction clearance, of the needles, to values that satisfy the Expression (1). Thus, a compelling force that is applied from the inner roller during rotational operation of the tripod constant-velocity joint is suppressed, whereby quietness can be increased to a desired level.

Therefore, according to the above aspect, a tripod constant-velocity joint that is excellent in quietness can be provided.

Note that reference signs in parentheses in the claims represent the corresponding relationships with specific means described in embodiments to be described later, and are not intended to limit the technical scope of the present disclosure.

### BRIEF DESCRIPTION OF THE DRAWINGS

The above and other objects, features and advantages of the present disclosure will become more apparent from the following detailed description with reference to the accompanying drawings. In the drawings;

FIG. 1 is an axial direction perspective view of a constant-velocity joint assembly including a tripod constant-velocity joint according to a first embodiment;

FIG. 2 is a cross-sectional view of FIG. 1 as viewed from an opening portion side of an outer ring;

FIG. 3 is an enlarged cross-sectional view of a peripheral portion of a roller unit that is situated on a torque transmission side in a width direction of a raceway groove in FIG. 2;

FIG. 4 is a diagram schematically illustrating a circumferential direction clearance of needles;

FIG. 5 is a graph showing correlation between a value of a left side of Expression (1) and a compelling force; and

FIG. 6 is a graph showing correlation between a value of a left side of Expression (2) and a compelling force.

### MODES FOR CARRYING OUT THE INVENTION

A tripod constant-velocity joint that is an embodiment of the above-described aspect will be described below with reference to the drawings.

Note that in the present specification and the drawings, unless otherwise specified, a needle axial direction of an outer ring is defined as an X-axis direction, an axial direction of needles making up a roller unit is defined as a Y-axis direction, and a needle circumferential direction that is a direction in which the needles are disposed is defined as a Z-axis direction.

### First Embodiment

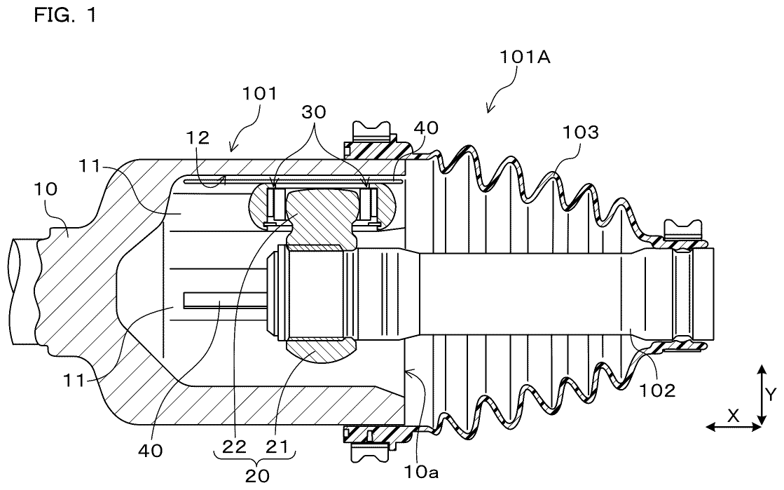

A tripod constant-velocity joint 101 according to a first embodiment illustrated in FIG. 1 is used in a power transmission shaft of a vehicle, for example. At this time, the constant-velocity joint 101, together with a shaft 102 and a boot 103, make up a constant-velocity joint assembly 101A. This constant-velocity joint assembly 101A is used in a linking part between a differential and wheels (both omitted from illustration).

### 1. Structure of Tripod Constant-Velocity Joint 101

As illustrated in FIG. 1, the tripod constant-velocity joint (hereinafter simply referred to as “constant-velocity joint”) 101 includes an outer ring 10, a tripod 20, and three roller units 30.

The outer ring 10 is formed in a cylindrical shape with a bottom, having an opening portion 10a at one end side in the axial direction X thereof. On the other hand, the outer ring 10 may be formed in a cylindrical that is open through in the axial direction X. A bottom face outer side of the outer ring 10 is linked to a differential. Three raceway grooves 11 are formed on an inner peripheral face of the outer ring 10 at equal intervals in the circumferential direction, extending in the axial direction X from the opening portion 10a of the outer ring 10 toward a deep side (left side in FIG. 1).

The tripod 20 is movable in the axial direction X and is also tiltable, with respect to the outer ring 10. The tripod 20 includes a boss 21 and three shaft portions (also referred to as “tripod shaft portions”) 22 extending outward in a radial direction from the boss 21. An outer peripheral face of each shaft portion 22 is formed as a spherical convex shape. That is to say, the outer peripheral faces of the shaft portions 22 in the axial direction are formed with arcuate convex cross-sectional shapes.

The shaft 102 is linked to the boss 21 of the tripod 20. In a state in which an angle is applied between the shaft 102 and the outer ring 10, torque is transmitted between the shaft 102 and the outer ring 10 via the tripod 20 and the roller units 30. An angle that is formed between the shaft 102 and the outer ring 10 at this time is called “joint angle” of the constant-velocity joint 101.

The boot 103 is expandable and contractible in the axial direction X and is also formed in a shape of an accordion tube that is bendable. One end portion of the boot 103 in the axial direction X is attached to the opening portion 10a side of an outer peripheral face of the outer ring 10, and the other end portion thereof in the axial direction X is attached to an outer peripheral face of the shaft 102. Thus, the boot 103 closes off the opening portion 10a side of the outer ring 10. The boot 103 has a function of sealing such that grease that is contained in an internal region of the outer ring 10 does not leak out from the opening portion 10a of the outer ring 10.

### 2. Structure of Roller Unit 30

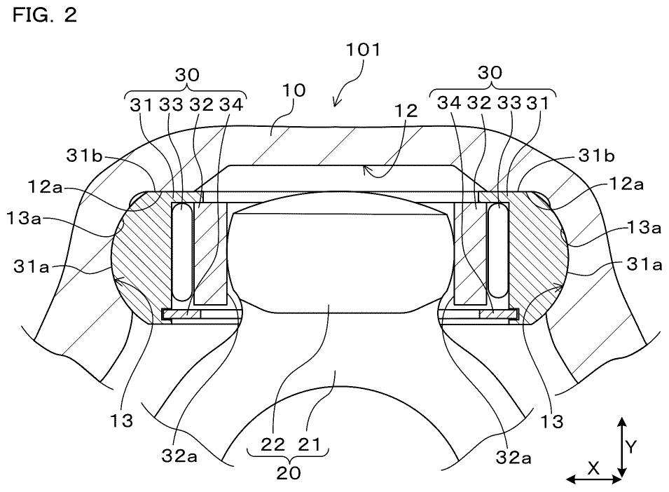

As illustrated in FIG. 2, the roller unit 30 is formed in an annular shape. The roller units 30 are supported so as to be rotatable on an outer circumferential side of each of the three shaft portions 22, so as to be slidable in an axial direction of each of the shaft portions 22, and also so as to be tiltable with respect to each of the shaft portions 22. Furthermore, each of the three roller units 30 is disposed so as to be able to roll along each of the three raceway grooves 11. Accordingly, the three roller units 30 are configured to roll in a state in which their orientations are maintained, relative to the three raceway grooves 11.

The roller unit 30 includes an outer roller 31, an inner roller 32, a needle 33, and a snap ring 34. The inner roller 32 is disposed on an inner side of the outer roller 31. The inner roller 32 is configured such that an inner peripheral face 32a thereof comes into contact with the outer peripheral face of the shaft portion 22. The needle 33 is a rolling element that is cylindrical and that is sandwiched between the outer roller 31 and the inner roller 32 in the radial direction. The snap ring 34 is engaged with an inner peripheral face of the outer roller 31. The snap ring 34 is a retaining member that prevents the inner roller 32 and the needle 33 from falling out in the needle axial direction Y relative to the outer roller 31. The snap ring 34 is also called “snap ring”. The roller unit 30, of a structure in which two rollers (outer roller 31 and inner roller 32) are disposed overlapping each other in the radial direction in this way, is a roller unit that is generally called a “double roller type”.

The outer ring 10 has a bottom portion 12, and groove side faces 13 that are situated on both sides of the bottom portion 12 in a groove width direction of the raceway grooves 11 (left-right direction in FIG. 2). The groove side faces 13 are formed with transmission faces 13a that transmit torque by coming into contact with an outer peripheral face of the roller unit 30 (outer peripheral face 31a of the outer roller 31). The cross-sectional shapes of the transmission faces 13a are concave shapes having a predetermined curvature or a combination of a plurality of curvatures.

The roller unit 30 is disposed such that the outer peripheral face 31a of the outer roller 31 is fitted into the two transmission faces 13a. The roller unit 30 is configured such that in a case in which the outer ring 10 rotates, the outer peripheral face 31a of the outer roller 31 is in contact with one of the two transmission faces 13a of the raceway groove 11 depending on the direction of rotation, thereby transmitting torque with respect to the outer ring 10. That is to say, switching the direction of rotation of the outer ring 10 switches the face of the two transmission faces 13a that comes into contact with the outer peripheral face 31a of the outer roller 31.

Now, out of the groove width directions of the raceway groove 11, a side to which torque is transmitted between the raceway groove 11 and the roller unit 30 in a case in which the outer ring 10 rotates is defined as “torque transmission side”. Further, the side opposite to the torque transmission side and an opposite side from the side where torque is transmitted between the raceway groove 11 and the roller unit 30 is defined as “counter torque transmission side”.

A support face 12a that faces one end face 31b of the outer roller 31 is provided at a predetermined position on the bottom portion 12 of the raceway groove 11. This support face 12a comes into contact with the roller unit 30 on the counter torque transmission side, which tilts in accordance with the torque transmission of the constant-velocity joint 101, and serves in a function of supporting the roller unit 30.

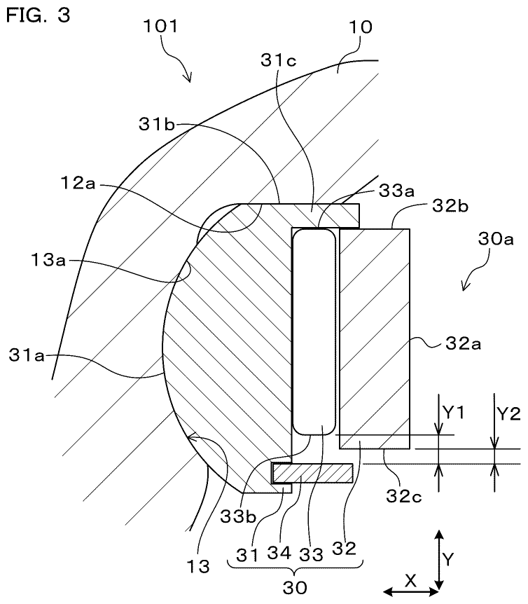

In the constant-velocity joint 101 according to the present embodiment, the roller unit 30 is provided with two clearance expansion structures 30a and 30b for expanding clearance around the needle 33. These two clearance expansion structures 30a, 30b will be described below with reference to FIG. 3 to FIG. 6.

### 3. Clearance Expansion Structure 30a

As illustrated in FIG. 3, the outer roller 31 of the roller unit 30 is provided with the snap ring 34 and a flange portion 31c that faces the needle axial direction Y. In a space between the flange portion 31c of the outer roller 31 and the snap ring 34, the inner roller 32 and the needle 33 are interposed together. Accordingly, the flange portion 31c functions as a regulating portion that restricts movement of the inner roller 32 and the needle 33 in the needle axial direction Y.

The clearance expansion structure 30a is a structure that sets a dimension Y1 of clearance between the needle 33 and the snap ring 34 in the needle axial direction Y so as to be no smaller than a dimension Y2 of clearance between the inner roller 32 and the snap ring 34 in the needle axial direction Y. That is to say, a value of the dimension Y1 may be equal to a value of the dimension Y2, or may be greater than the value of the dimension Y2.

Now, the dimension Y1 is defined as the dimension of clearance that is formed between another end face 33b of the needle 33 in the needle axial direction Y and the snap ring 34 in a case in which one end face 33a of the needle 33 in the needle axial direction Y is abutted against the flange portion 31c of the outer roller 31. In the same way, the dimension Y2 is defined as the dimension of clearance that is formed between another end face 32c of the inner roller 32 in the needle axial direction Y and the snap ring 34 in a case in which one end face 32b of the inner roller 32 in the needle axial direction Y is abutted against the flange portion 31c of the outer roller 31.

According to this clearance expansion structure 30a, the clearance that is formed between the needle 33 and the snap ring 34 in the needle axial direction Y can be expanded. This reduces frequency of contact between the one end face 33a of the needle 33 and the flange portion 31c of the outer roller 31, and between the other end face 33b of the needle 33 and the snap ring 34. Accordingly, rotational resistance of the needle 33 can be reduced.

### 4. Clearance Expansion Structure 30b

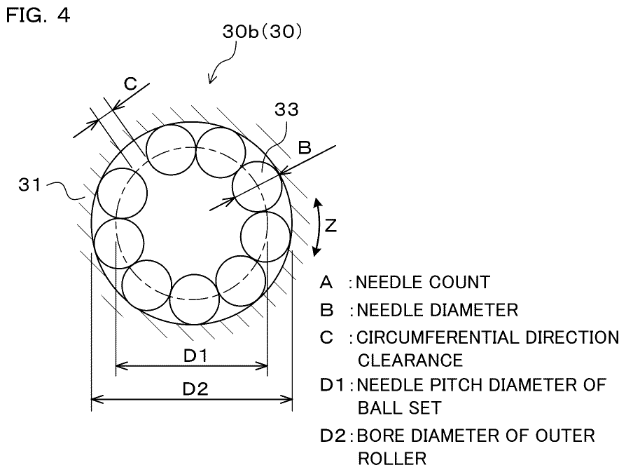

As illustrated in FIG. 4, the clearance expansion structure 30b is a structure that, with A representing a needle count of the needles 33, B representing a needle diameter of the needles 33, and C representing the circumferential clearance of needles 33 in the needle circumferential direction Z, sets the values of the needle count A, the needle diameter B, and the circumferential direction clearance C, so as to be values that satisfy the following Expression (1).

In FIG. 4, D1 represents a needle pitch diameter of ball set and D2 represents a bore diameter of the outer roller 31, and the needles 33 are illustrated schematically for the sake of convenience. Note that the circumferential direction clearance C of the needles 33 is defined as a gap that is formed at one location in a case in which all the needles 33 are gathered together in the needle circumferential direction Z.

$$( C / ( A \times B + C ) \times 100 \geq 0.678 \qquad ( 1 )$$

Now, Expression (1) was derived by the present inventor based on evaluation results of the constant-velocity joint 101 that was actually used. The term corresponding to (A×B+C) on the left side of Expression (1) is an approximation of the pitch length of the arcuate length of the needle pitch circle by using the needle diameter B that is the straight line length, for the sake of convenience.

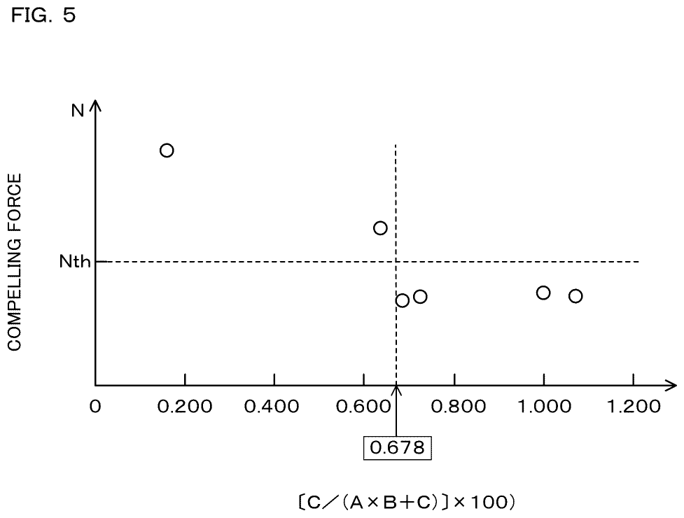

As shown in FIG. 5, the present inventor performed actual measurement of a compelling force N that was applied from the inner roller 32 when the value of the circumferential direction clearance C of the needles 33 was changed in various ways, using a known vibration measuring device. At this time, the circumferential direction clearance C of the needles 33 can change depending on the parameters of the needle count A, the needle diameter B, and the needle pitch diameter of ball set D1, as shown in the following Expression (1a). Accordingly, the value of the circumferential direction clearance C of the needles 33 can be changed by appropriately changing the combination of values of these parameters.

$$C = [ ( D 1 \times sin ( π / A ) ) - B ] \times A \qquad ( 1 a )$$

Note that in a case in which the constant-velocity joint 101 is rotated under a torque loaded state with a joint angle applied, the vibrational compelling force caused by frictional force generated between the three shaft portions 22 of the tripod 20 and the roller units 30 is a rotational third-order vibrational compelling force due to vibration occurring three times during one rotation. Accordingly, in the present embodiment, actual measurement of the rotational third-order vibrational compelling force is made for the compelling force N. This vibrational compelling force is generated when the inner rollers 32 come into contact with the flange portions 31c of the outer rollers 31 in accordance with change in the joint angle.

In a case based on the above evaluation results, the present inventor found that among the actual measured values (plotted by circles), effects of suppressing the compelling force N were high in those in which the compelling force N was below a threshold value Nth, which is to say those in which the value of the left side of Expression (1) was no lower than 0.678, and thus this is effective in reducing the quietness of the vehicle to a desired level. Employing the clearance expansion structure 30b enables vibrations that are transmitted to a vehicle body via the shaft 102 during the rotational operation of the constant-velocity joint 101 to be kept low, thereby ensuring quietness of the vehicle.

Note that in the clearance expansion structure 30b, instead of using the above Expression (1), the circumferential direction clearance C of the needles 33 and the needle pitch diameter of ball set D1 thereof may be set to values that satisfy the following Expression (2).

$$( C / ( D 1 \times π ) ) \times 100 \geq 0 \text{.678} \qquad ( 2 )$$

Now, Expression (2) was derived by the present inventor based on evaluation results of the constant-velocity joint 101 that was actually used, in the same way as with Expression (1). The term corresponding to (D1×π) on the left side of Expression (2) is the length of an arc, and accordingly the pitch length can be derived more precisely as compared to the term corresponding to (A×B+C) on the left side of Expression (1) that uses the needle diameter B, which is the straight line length.

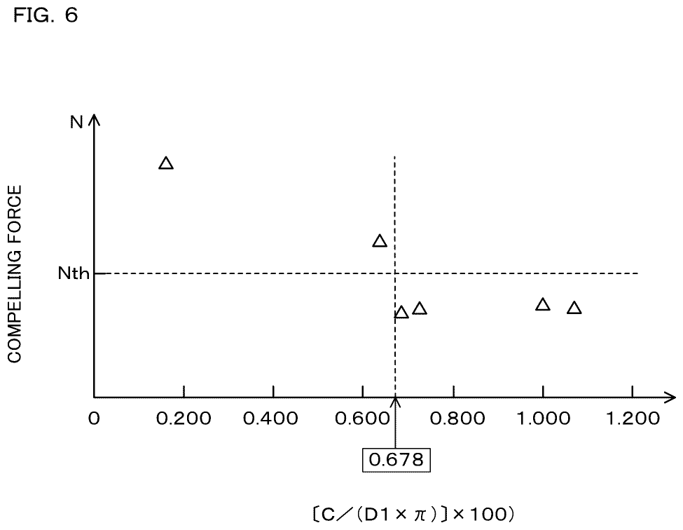

As shown in FIG. 6, actually-measured values (plotted by triangles) are roughly in agreement with the measured values (plotted by circles) in FIG. 5. For this reason, it was confirmed that, among the actual measured values (plotted by triangles) in FIG. 6, effects of suppressing the compelling force N were high in those in which the compelling force N was below the threshold value Nth, which is to say those in which the value of the left side of Expression (2) was no lower than 0.678, in the same way as in the case of FIG. 5, and thus this is effective in reducing the quietness of the vehicle to a desired level. That is to say, the value on the left side of Expression (1) and the value on the left side of Expression (2) are roughly the same, and in both Expressions, a lower limit value is set to 0.678.

Note that the circumferential direction clearance C of the needles 33 is never equal to or greater than the size of one needle 33. Accordingly, an upper limit value of the circumferential direction clearance C is preferably set to a value that is equivalent to the needle diameter B of the needles 33. Of course, an appropriate value below the needle diameter B may be set as the upper limit value.

### 5. Effects

Next, functions and effects of the above-described first embodiment will be described.

In the constant-velocity joint 101 of the first embodiment described above, the roller unit 30 is provided with two clearance expansion structures 30a and 30b. Employing these two clearance expansion structures 30a and 30b enables expanding both the clearance in the needle axial direction Y and the clearance in the needle circumferential direction Z of the needles 33. Thus, the compelling force N applied from the inner rollers 32 during rotational operation of the constant-velocity joint 101 is suppressed, whereby quietness can be increased to a desired level. These two clearance expansion structures 30a and 30b are highly versatile structures that can be applied regardless of changes in the size of the constant-velocity joint 101 and so forth.

Although the present disclosure has been described with reference to the above form, it is understood that the present disclosure is not limited to these forms or structures. The present disclosure also encompasses various modifications and variations within the scope of equivalents. Additionally, various combinations and forms, as well as other combinations and forms that include only one element, more than this, or less than this, are within the scope and spirit of the present disclosure.

In the form described above, a case in which the roller unit 30 is provided with the two clearance expansion structures 30a and 30b is exemplified, but alternatively, the roller unit 30 may be provided with just the clearance expansion structure 30b. The clearance expansion structure 30b is particularly effective in suppressing the compelling force N that is applied from the inner roller 32 during the rotational operation of the constant-velocity joint 101.

Although a constant-velocity joint 101 that is used in a power transmission shaft of a vehicle has been exemplified in the above embodiment, the constant-velocity joint 101 may also be applied to a steering shaft (steering) of a vehicle.

1. A tripod constant-velocity joint comprising:
an outer ring having a plurality of raceway grooves extending in an axial direction;
a tripod having three shaft portions; and
a plurality of roller units formed in an annular shape, rotatably supported on each of the three shaft portions, and also each rolling in each of the plurality of raceway grooves, wherein
each of the plurality of roller units has an outer roller, an inner roller, and a needle that is cylindrical and that is sandwiched between the outer roller and the inner roller, and
a needle count (A), a needle diameter (B), and a circumferential direction clearance, (C) of the needles, are set to values that satisfy the following Expression (1): (C/(A×B+C)×100≥0.678 . . . (1).

2. The tripod constant-velocity joint according to claim 1, wherein
each of the plurality of roller units is configured such that a value corresponding to the needle diameter is set as an upper limit value of the circumferential direction clearance.

3. The tripod constant-velocity joint according to claim 1, wherein:
each of the plurality of roller units has a snap ring that serves as a detachment stopper for the inner roller and the needle with respect to the outer roller in a needle axial direction; and
a configuration is made such that a dimension of a clearance between the needle and the snap ring in the needle axial direction is no smaller than a dimension of a clearance between the inner roller and the snap ring in the needle axial direction.
